(19) United States
(12) Patent Application Publication
(10) Pub. No.: US 2005/0256597 A1
(43) Pub. Date: Nov. 17, 2005

(54) Method for transferring production lots for experiment

(76) Inventors: Jen-Lin Chao, Hisinchu (TW); Chen-Wei Hsu, Hsinchu City (TW)

Correspondence Address: THOMAS, KAYDEN, HOSTEMEYER & RISLEY LLP, 100 GALLERIA PARKWAY, SUITE 1750, ATLANTA, GA, 30339, US

(21) Appl. No.: 10/847,115

(22) Filed: May 17, 2004

(51) Int. Cl. G06F 19/00

(52) U.S. Cl. 700/96; 700/100

(57) ABSTRACT

A method for transferring production lots for experiment. An experiment request for a product is first received. A plurality of production lots corresponding to the product is then displayed showing which production lots presently being processed on a production line. At least one of the stages and at least one of the production lots that have not been processed at the stage are selected. Thereafter, a hold flag is set at the stage, such that the selected production lot is held for an experiment at the stage.

### BACKGROUND

The present invention relates to production management and particularly to a method for transferring production lots for experiment that rapidly transfers production lots presently processed on a production line to experiment lots, and automatically holds experiment lots at specific user-determined stages.

Prior to mass production of a product design, clients take orders to do engineering experiments for the product design. Clients further continue performing experiments for the product design after it has been produced on a production line to improve production yield and reducing related costs. FIG. 1 illustrates a production yield ramp up trend. The yield trend A is raised to a saturation target ST by repeated experiments through pilot period P1 and mass production period P2.

In conventional production systems, the experiment orders are handled as new production, that is, supply chain management including capacity allocation and the like must be performed for the experiment orders. The entire experiment cycle time is long. Since there may be an overload capacity, the experiment orders must compete with other orders to gain required capacity, thereby further lengthening the experiment cycle time.

Additionally, the experiment lots are held and experimented on according to client directions. The delivery issue is relatively unimportant for the experiment lot. The delivery issue is, however, important for normal production lots, and is handled by following the MPS (Manufacturing Planning Schedule) determined by a planning engine. The experiment and production lots are easily mixed and confused in production systems, and may result in an incorrect delivery dispatch. Additionally, since production control personnel and experiment engineers of the client are often distinct entities, it is necessary to provide the production control personnel with the experiment information, and delivery management should be further enhanced for the experiment lots.

### SUMMARY

The present disclosure addresses the aforementioned issues. It is noted that the present invention is applicable to any factory, service supplier and product.

Accordingly, it is an object of the present invention to provide a method for transferring production lots for experiment that rapidly transfers production lots presently processed on a production line to experiment lots, and automatically holds experiment lots at specific user-determined stages.

The present disclosure provides a method for transferring production lots for experiment, in which an experiment request for a product is first received via a web interface. A plurality of production lots corresponding to the product is then displayed on the web interface. The production lots presently being processed on a production line comprise a sequence of stages. At least one of the stages and at least one of the production lots that have not been processed at the stage are selected. Thereafter, a hold flag is set at that stage, such that the selected production lot is held for an experiment.

An experiment condition is further received via the web interface, and the experiment is performed on the selected production lot accordingly.

An original order corresponding to the selected production lot is further split to generate an experiment order comprising the selected production lot, the selected production lot is pegged to the experiment order, and a committed date is determined for the experiment order.

The above-mentioned method may take the form of program code embodied in a tangible media. When the program code is loaded into and executed by a machine, the machine becomes an apparatus for practicing the invention.

### BRIEF DESCRIPTION OF THE DRAWINGS

The aforementioned objects, features and advantages will become apparent by referring to the following detailed description of the preferred embodiment with reference to the accompanying drawings, wherein:

FIG. 1 illustrates a production yield ramp up trend;

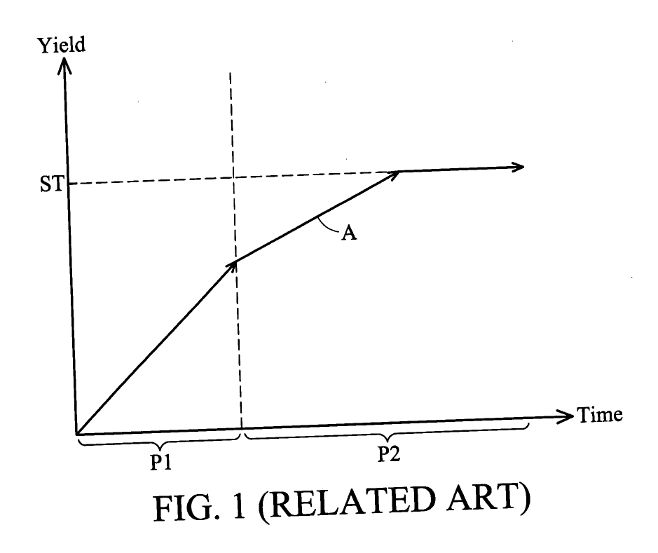

FIG. 2 is a flowchart showing the operation for transferring production lots for experiment according to one embodiment of the present invention;

FIG. 3 is an example of a web interface displaying production lots;

FIG. 4 is a flowchart showing the operation for experiment management according to one embodiment of the present invention;

FIG. 5 is a schematic diagram illustrating a storage medium for storing a computer program for execution of the method for transferring production lots for experiment according to one embodiment of the present invention;

FIG. 6 illustrates an improved production yield ramp up trend; and

FIG. 7 is a schematic diagram illustrating the architecture practicing the method for transferring production lots for experiment according to one embodiment of the present invention.

### DESCRIPTION

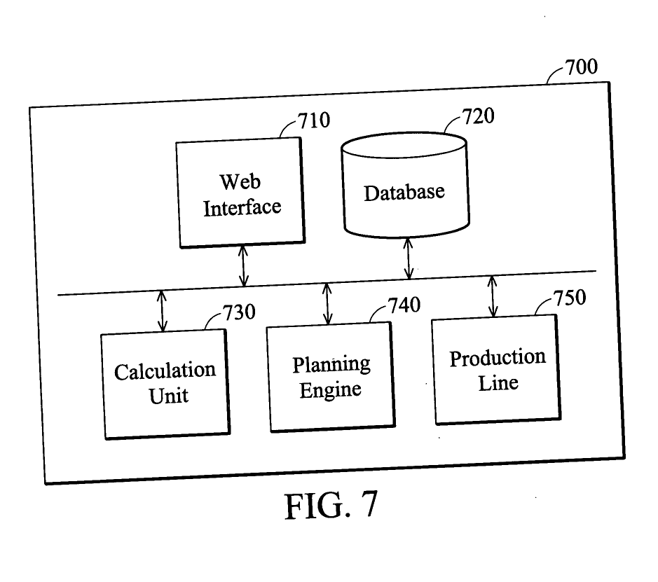

FIG. 7 is a schematic diagram illustrating a system practicing the method for transferring production lots for experiment according to one embodiment of the present invention.

The system 700 includes a web interface 710, a database 720, a calculation unit 730, a planning engine 740 and a production line 750. The web interface 710 receives information or requests from clients, and display related results thereon. It is understood that the present invention can be integrated with a web-based platform, which provides online service to clients. The database 720 stores related manufacturing information, such as WIP (Work In Process) status, lot distribution, and others. It is understood that the present invention may couple to related systems, such as a planning system and a manufacturing execution system to collect the manufacturing information. The calculation unit 730 performs the method for transferring production lots for experiment, and its operation is discussed below. The planning engine 740 performs related supply chain management. The production line 750 includes a plurality of stages performing respective process to products/wafers.

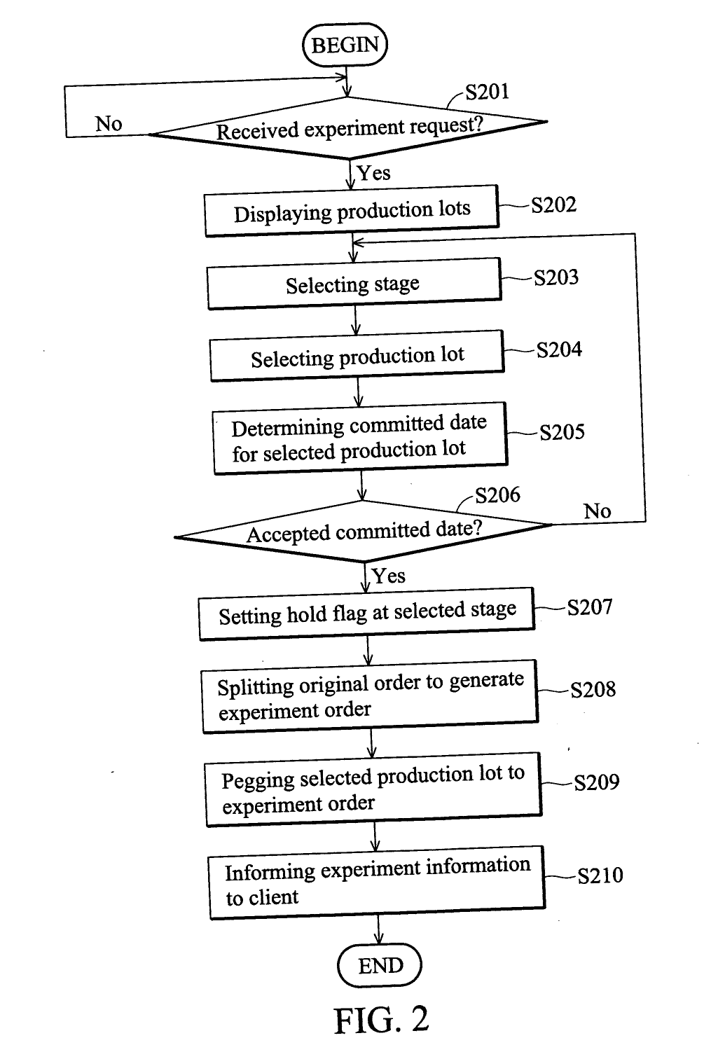

FIG. 2 shows the operation for transferring production lots for experiment according to one embodiment of the present invention.

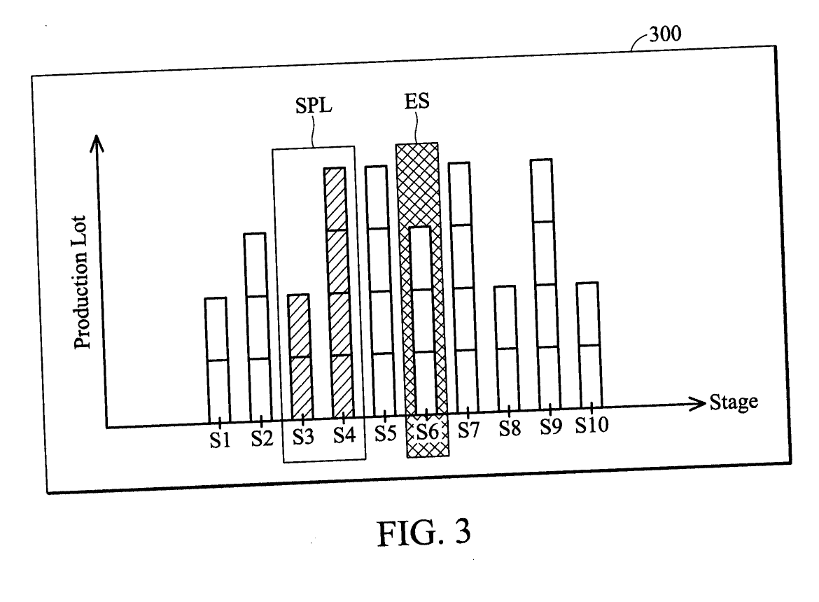

First, in step S201, it is determined whether an experiment request for a specific product has been received from a client. The experiment request can be received via the web interface 710. The procedure remains at step S201 until an experiment request has been received. Upon receiving an experiment request a plurality of production lots corresponding to the product is then displayed, in step S202, on the web interface 300, as shown in FIG. 3. It is understood that the production lots are presently processed on the production line 750. The production line 750 comprises a sequence of stages.

Thereafter, in steps S203 and S204, at least one of the stages and at least one of the production lots that have not been processed at the stage are selected via the web interface 300. In the example of FIG. 3, there are 10 stages S1-S10 in the production line, with several production lots presently being processed at each stage, respectively. In other words, FIG. 3 shows a snapshot of the production line as the products move through the 10 stages. Thus, for example, in the next snapshot, the production lots that are currently at stage S1 will move to stage S2; the production lots that are currently at stage S2 will move to stage S3; the production lots that are currently at stage S3 will move to stage S4, and so on. This is discussed in greater detail below, with reference to FIG. 3.

The selected stage ES and production lots SPL are marked for experiment. Thus, pending other conditions described below, when those selected production lots SPL reach the selected stage ES (which is stage S6 in FIG. 3), the selected production lots SPL are tested accordingly.

Continuing with the description of FIG. 2, in step S205, a committed date is determined for the selected production order. It is understood that the committed date can be the MPS date of the selected production order or the MPS date with a buffer time extension, and the committed date can be displayed on the web interface.

Then, in step S206, it is determined whether the committed date has been accepted by the client. If the committed date is not accepted by the client, then the procedure returns to step S203. Otherwise, in step S207, a hold flag is set at the selected stage, such that the selected production lot is held for an experiment upon arrival at the selected stage. Thereafter, in step S208, an original order corresponding to the selected production lot is split to generate an experiment order including the selected production lot, and in step S209, the selected production lot is hard pegged to the experiment order, such that the selected production lot cannot be confused with normal production lots during delivery. It is understood that “Hard Peg” is an instruction in planning engines, and it can link specific lots to a specific order, thereby avoiding mistakes in delivery. It is also understood that the committed date for the experiment order can be set into the planning engine 740, and the planning engine 740 may perform related supply chain management accordingly. Thereafter, in step S210, the experiment information is informed and provided to the client, and the production control personnel.

FIG. 3 is an example of a web interface displaying production lots that traverse a production line. It should be noted that FIG. 3 shows only one specific example, in an effort to more clearly describe various aspects of the inventive concept.

As shown in the example of FIG. 3, the production line has multiple stages. Specifically, for FIG. 3, there are ten (10) stages, which sequentially span stage S1 through stage S10. The production lots traverse the production line through each of the ten stages. In this regard, the two blocks currently shown at stage S1 of FIG. 3 will subsequently proceed to stage S2 and, thereafter, proceed to stage S3, and so on.

The interface of FIG. 3 permits an operator to select production lots for experimentation. Specifically, as shown in FIG. 3, the production lots that are currently at stages S3 and S4 have been selected for experimentation. Similarly, the interface of FIG. 3 permits the operator to select a stage at which those selected production lots are to be tested. As shown in FIG. 3, stage S6 is selected as the experiment stage ES.

Thus, in the example of FIG. 3, when the production lot that is currently at stage S4 proceeds to S5 and then to S6, that production lot will become the subject of experimentation upon reaching stage S6. Similarly, when the production lot that is currently at stage S3 proceeds through S4 and S5, upon reaching stage S6, that production lot will become the subject of experimentation.

It should be appreciated that the experiment conditions, for some embodiments, can be defined by a client and received over the web interface.

Since the production line proceeds sequentially from S1 through S10, it should be appreciated that, if stage S6 is selected as the experiment stage ES, then, in some embodiments, those production lots that are currently at stages S7, S8, S9, or S10 cannot be selected for experiment.

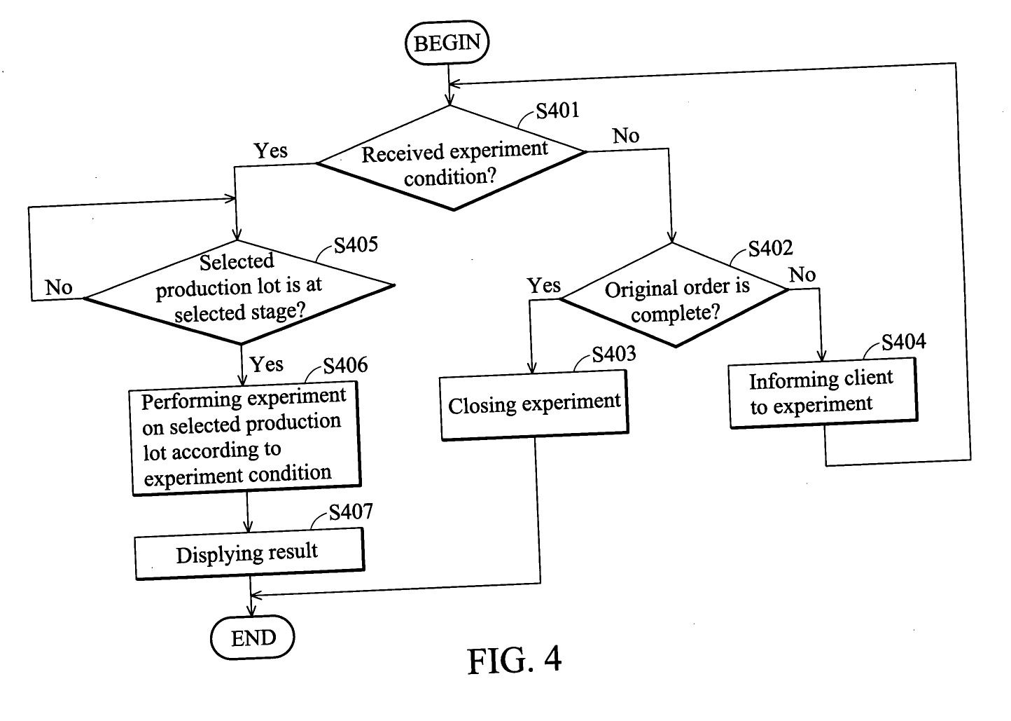

FIG. 4 shows the operation for experiment management according to one embodiment of the present invention.

First, in step S401, it is determined whether an experiment condition has been received from the client. Similarly, the experiment condition can be received via the web interface. If no experimental condition has been received, then, in step S402, it is determined whether the original order is complete. If the original order is complete, then, in step S403, the experiment is closed. It is understood that the selected production lot may be released at the selected stage, and performed using an original recipe for the product if the original order is complete. If the original order is not complete, then, in step S404, a notification message is transmitted to inform the client to perform the experiment, and the procedure returns to step S401.

If an experiment condition is received from the client, then, in step S405, it is determined whether the selected production lot is at the selected stage. If the selected production lot is not at the selected stage, then the procedure remains in step S405. Once the selected production lot reaches the selected stage, in step S406, the experiment is performed on the selected production lot according to the received experiment condition. Thereafter, in step S407, a result of the experiment is displayed on the web interface. It is understood that the result may also be transmitted to the client via email.

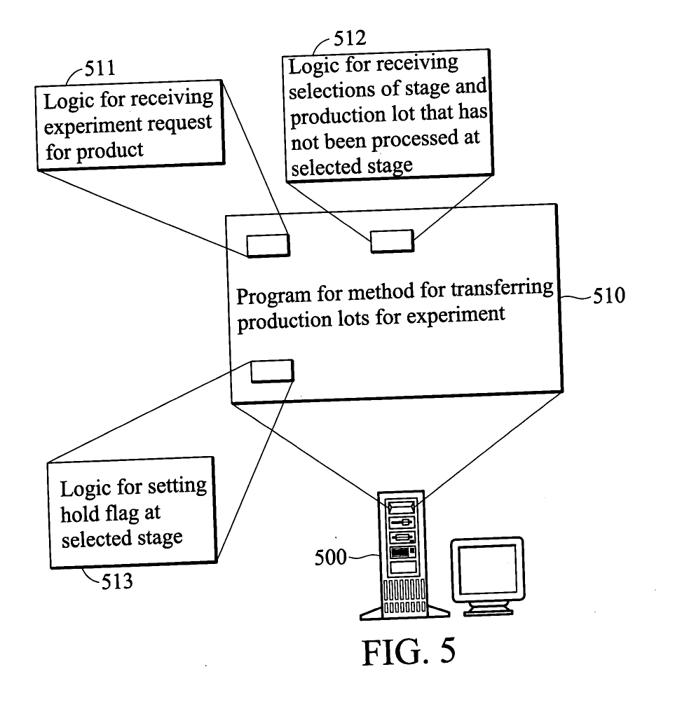

FIG. 5 is a diagram of a storage medium storing a computer program providing the method for transferring production lots for experiment according to one embodiment of the present invention. The computer program is stored on a storage medium 510. As such, the storage medium comprises computer readable program code for use in a computer system 500. The computer readable program code comprises at least computer readable program code 511 receiving an experiment request for a product, computer readable program code 512 for receiving selections of at least one stage, and at least one production lot that has not been processed at the stage, and computer readable program code 513 for setting a hold flag at the stage, such that the selected production lot is held for an experiment at the stage.

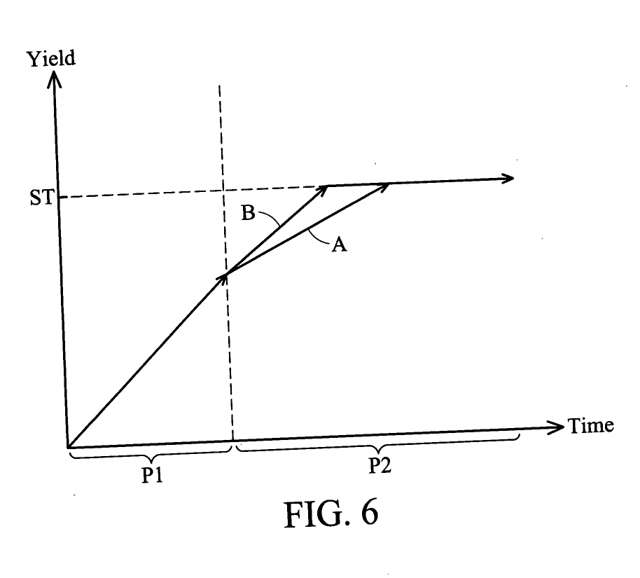

FIG. 6 illustrates an improved production yield ramp up trend according to the present invention. In contrast to the conventional yield trend A, the improved yield trend B shortens the time to the saturation target ST. The present invention thus provides a method for transferring production lots for experiment that rapidly transfers production lots presently being processed on a production line to experiment lots, and automatically holds experiment lots at specific user-determined stages, thereby shortening yield ramp up cycle time, increasing production competitiveness, and improving delivery quality of experiment lots.

The method and system of the present invention, or certain aspects or portions thereof, may take the form of program code (i.e., executable instructions) embodied in tangible media, such as floppy diskettes, CD-ROMS, hard drives, or any other machine-readable storage medium, wherein, when the program code is loaded into and executed by a machine, such as a computer, the machine becomes an apparatus for practicing the invention. The method and systems of the present invention may also be embodied in the form of program code transmitted over transmission media, such as electrical wiring or cabling, through fiber optics, or via any form of transmission, wherein, when the program code is received and loaded into and executed by a machine, such as a computer, the machine becomes an apparatus for practicing the invention. When implemented on a general-purpose processor, the program code combines with the processor to provide a unique apparatus that operates analogously to application specific logic circuits.

Although the present invention has been described in its preferred embodiments, it is not intended to limit the invention to the precise embodiments disclosed herein. Those skilled in this technology can still make various alterations and modifications without departing from the scope and spirit of this invention. Therefore, the scope of the present invention shall be defined and protected by the following claims and their equivalents.

1. A method for transferring production lots for experiment, comprising the steps of:
indicating at least one stage among a plurality of stages of a production line, in which a plurality of production lots are sequentially processed through the stages;
selecting at least one of the production lots that has not been processed at the indicated stage; and
holding the selected production lot for an experiment at the indicated stage.

2. The method of claim 1 further comprising displaying all of the production lots on an interface, the interface showing the production lots that are presently processed on the production line.

3. The method of claim 1 further comprising splitting an original order corresponding to the selected production lot to generate an experimental order indicating the selected production lot.

4. The method of claim 3 further comprising determining a committed date for the experimental order.

5. The method of claim 3 further comprising pegging the selected production lot to the experimental order.

6. The method of claim 1 further comprising receiving an experimental condition via an interface, and performing the experiment on the selected production lot according to the experimental condition.

7. The method of claim 6 further comprising displaying a result of the experiment on the interface.

8. A method for transferring production lots for experiment, comprising the steps of:
receiving an experiment request for a product via a web interface, in which the experiment request indicates a request of an experiment for the product on one or more stages of a production line;
displaying a plurality of production lots corresponding to the product on the web interface, the web interface showing the production lots that are presently processed on the production line, the production line comprising a sequence of stages, and the production lots are configured to be sequentially processed through the stages;
selecting at least one of the stages;
selecting at least one of the production lots that have not been processed at the selected stage; and
setting a hold flag at the selected stage, such that the selected production lot is held for an experiment at the selected stage.

9. The method of claim 8 further comprising splitting an original order corresponding to the selected production lot to generate an experimental order indicating the selected production lot.

10. The method of claim 9 further comprising determining a committed date for the experimental order.

11. The method of claim 9 further comprising pegging the selected production lot to the experimental order.

12. The method of claim 8 further comprising receiving an experimental condition via the web interface, and performing the experiment on the selected production lot according to the experimental condition.

13. The method of claim 12 further comprising displaying a result of the experiment on the web interface.

14. A machine-readable storage medium storing a computer program which, when executed, directs a computer to perform a method for transferring production lots for experiment, the method comprising the steps of:
receiving an experiment request for a product, in which the experiment request indicates a request of an experiment for the product on one or more stages of a production line;
receiving selections of at least one stage among the stages, and at least one production lot that has not been processed at the selected stage, in which the selected production lot is selected from a plurality of production lots sequentially processed through the stages; and
setting a hold flag at the selected stage, such that the selected production lot is held for an experiment at the selected stage.

15. The storage medium of claim 14 wherein the method further comprises a step of displaying all of the production lots on an interface, the interface showing the production lots are presently processed on the production line.

16. The storage medium of claim 14 wherein the method further comprises a step of splitting an original order corresponding to the selected production lot to generate an experimental order indicating the selected production lot.

17. The storage medium of claim 16 wherein the method further comprises a step of determining a committed date for the experimental order.

18. The storage medium of claim 16 wherein the method further comprises a step of pegging the selected production lot to the experimental order.

19. The storage medium of claim 14 wherein the method further comprises steps of receiving an experimental condition via the web interface, and performing the experiment on the selected production lot according to the experimental condition.

20. The storage medium of claim 19 wherein the method further comprises a step of displaying a result of the experiment on an interface.

21. A method comprising the steps of:
displaying a production line on a graphical interface, the production line having stages, at least one of the stages being user-selectable, the production line further including production lots, at least one of the production lots being user-selectable, the production lots being configured to sequentially proceed through the multiple stages;
receiving a selection of a one of the stages, the selection being received using the graphical interface;
receiving a selection of a one of the production lots, the selection being received using the graphical interface; and
setting a hold flag in response to receiving the selection of the stage and the production lot such that the selected production lot is held at the selected stage for experiment.
